(19) United States
(12) Patent Application Publication
(10) Pub. No.: US 2008/0157698 A1
(43) Pub. Date: Jul. 3, 2008

(54) LED Lighting Unit

(76) Inventors: Boon Keat Tan, Gelugor (MY); Kok Chin Pan, Tanjung Bungah (MY)

Correspondence Address: Kathy Manke;Avago Technologies Limited, 4380 Ziegler Road, Fort Collins, CO, 80525, US

(21) Appl. No.: 11/618,352

(22) Filed: Dec. 29, 2006

(51) Int. Cl. H05B 37/02

(52) U.S. Cl. 315/294

(57) ABSTRACT

A lighting unit having a light generating section and a base section is disclosed. The base and light generating sections are reversibly connected by a series of mating connectors. The light generating section includes a plurality of groups of LEDs and a mixing structure. The base section includes an adapter that connects the lighting unit to an AC power receptacle designed to receive an incandescent lamp or a fluorescent lamp. The base section also includes a controller that powers the LEDs. The lighting unit also includes a sensor that periodically measures a parameter related to the intensity of light generated by each group of LEDs during the normal operation of the lighting unit. The controller uses this sensor to control the LEDs. The lighting section can also include a housing that has the shape of a conventional incandescent or fluorescent light fixture or light bulb.

### BACKGROUND OF THE INVENTION

Light-emitting diodes (LEDs) are attractive candidates for the replacement of conventional light sources based on incandescent and fluorescent lights. LEDs have significantly higher power efficiencies than incandescent lights and have much greater lifetimes. In addition, LEDs do not require the high voltage systems associated with fluorescent lights and can provide light sources that more nearly approximate “point sources”. The latter feature is particularly important for light sources that utilize collimating or other imaging optics.

To provide a replacement for conventional incandescent lights, an LED source must include a number of LEDs and control circuitry that operates the individual LEDs to provide a light bulb replacement that maintains a constant color and can be varied in intensity in a manner that is responsive to a dimmer control.

LEDs emit light in a relatively narrow spectral band. Hence, to provide a light source of an arbitrary perceived color, the light from a number of LEDs must be combined in a single light fixture or some form of phosphor conversion layer must be used to convert the narrow band of light to light having the desired color. While this complicates the construction of some LED light sources, it also provides the basis for light sources having a color that can be varied by altering the ratios of the light emitted by the various colored LEDs or an intensity by varying the power to all of the LEDs. In contrast, conventional light sources based on fluorescent tubes emit light of a fixed color and intensity.

A light source based on a single LED is relatively limited in the amount of light that the light source can generate. Typically, LEDs have power dissipations that are less than a few watts. Hence, to provide a high intensity light source to replace conventional light fixtures, a relatively large number of LEDs must be used in each light source.

In addition, LEDs age with use. Typically, the light output decreases with use and, in some cases, the spectrum emitted by the LED shifts with age giving rise to color shifts. In general, LEDs that emit different colors of light have different aging characteristics, since the aging profile of an LED depends on the fabrication process and materials, as well as other factors. In a light source based on three different color LEDs, the shift in intensity and/or spectrum causes the light emitted by the source to shift in color. To correct for these problems, many LED light sources include some form of photodetector that measures the light generated by the LEDs and a controller that adjusts the drive currents to each LED to maintain the desired color.

The dimming and color maintenance functions are typically performed by some form of controller and drive circuits that provide current to the LEDs. The control of the intensity of the light from the LEDs typically involves turning the LEDs on and off at a frequency that is too high for a human observer to detect. The intensity is adjusted by adjusting the fraction of the drive cycle during which the LED is turned on. The maintenance of a preset color requires photodetectors and a servo that operates the drive circuits. In addition, other functions that utilize power line communications to implement remote control of the light source have also been proposed. Finally, to replace a conventional incandescent lamp, an AC to DC converter must be included in the light source, since LEDs operate on DC. All of this circuitry represents a significant fraction of the cost of providing an LED-based replacement for conventional light sources.

### SUMMARY OF THE INVENTION

The present invention includes a lighting unit having a light generating section and a base section. The light generating section includes a plurality of groups of LEDs, each group emitting light of a different spectrum than the other groups, one of the groups including a plurality of LEDs. The light generating section also includes a light mixing structure that scatters light generated by the LEDs to produce a light output that is more uniform in color and intensity than that generated by the LEDs. The light generating section also includes a plurality of light generating section connectors that provide power to the LEDs. Each group of LEDs generates light at an intensity determined by a corresponding signal received on the light generating section connectors. The base section includes an adapter that connects the lighting unit to an AC power receptacle designed to receive an incandescent lamp or a fluorescent lamp. The base section also includes a controller that generates and couples the signals to the LEDs and a power converter that converts AC power from the adapter to DC power that powers the controller. The base section includes a plurality of base section connectors that are connected to the controller, each base section connector reversibly mating with a corresponding one of the light generating section connectors. The lighting unit also includes a sensor that periodically measures a parameter related to the intensity of light generated by each group of LEDs during the normal operation of the lighting unit. The controller generates the signals that are coupled to the LEDs based on the measured parameter. In one aspect of the invention, the sensor includes a photodetector that measures the intensity of light generated by each group of LEDs. In another aspect of the invention, the sensor measures a temperature related to the temperatures of the LEDs. The sensor can be located in the light generating section or the base section. In another aspect of the invention, the base section further includes a communication interface for sending and receiving information between the controller and a device connected to the AC power receptacle. In yet another aspect of the invention, the light generating section includes a housing that contains the LEDs and the mixing structure, the housing having a shape and dimensions that match a corresponding commercially available incandescent or fluorescent lamp.

### BRIEF DESCRIPTION OF THE DRAWINGS

FIG. 1 is a prior art block diagram of an embodiment of a three-color light source 40 that has been suggested as a replacement for a conventional light source such as an incandescent lamp.

FIG. 2 is a cross-sectional view of one embodiment of a light source according to the present invention.

FIG. 3 is a magnified cross-sectional view of a portion of light source 30 shown in FIG. 2.

FIG. 4 is a cross-sectional view of another embodiment of a light source according to the present invention.

FIG. 5 is a magnified cross-sectional view of a portion of light source 80 shown in FIG. 4 according to another embodiment of the present invention.

### DETAILED DESCRIPTION OF THE PREFERRED EMBODIMENTS

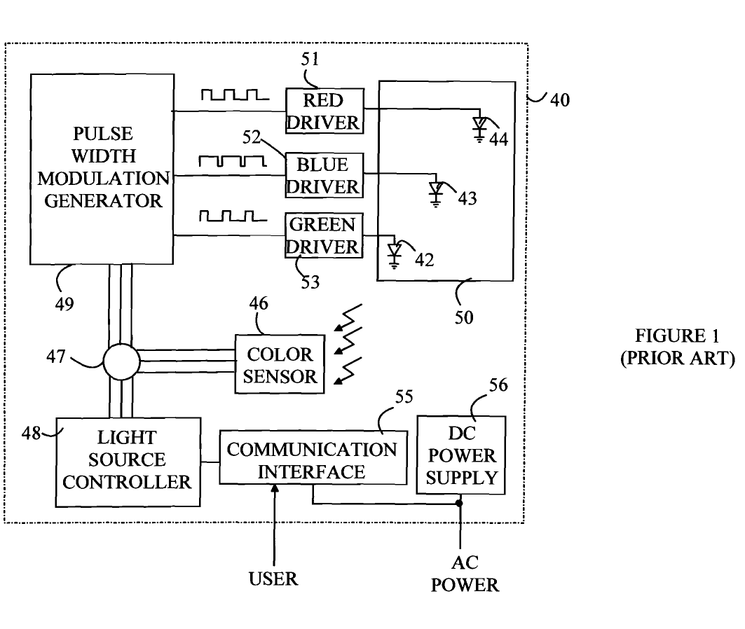

The manner in which the present invention provides its advantages can be more easily understood with reference to FIG. 1, which is a block diagram of a prior art embodiment of a three-color light source 40 that has been suggested as a replacement for a conventional light source such as an incandescent lamp. Light source 40 includes three groups of LEDs shown at 50. The red, blue, and green LEDs shown at 42-44, respectively, are controlled by a color controller. To simplify the drawing, each group of LEDs has been represented by a single LED; however, it is to be understood that each of the LEDs shown at 42-44 is typically a string of individual LEDs connected in series. The number of LEDs in each string depends on the maximum power that is to be provided by the light source. The strings of LEDs are typically provided with some form of mixing chamber that assures that the light leaving the light source appears to be a uniform light source having the same color independent of the viewing angle rather than a collection of point sources.

Light source 40 includes a color sensor 46 that samples the light generated by the LEDs after the light has been mixed. Color sensor 46 generates three signals that represent the intensity of light being generated by each string of LEDs. A number of different LED intensity measuring schemes are known to the art, and hence, the details of the various schemes will not be discussed in detail here. For the purposes of this discussion, it will be assumed that color sensor 46 is constructed from a set of three photodiodes in which each photodiode has a corresponding bandpass filter that limits the light reaching that photodiode to light in one of the three optical bands and a processor that computes the intensity of the light generated from each string of LEDs from the outputs of these photodiodes. However, many other forms of color sensor are known to the art and could be utilized.

The LEDs are turned on and off at a rate that is too fast for the human eye to perceive. The observer sees only the average light generated by the LEDs. The average current through the LEDs is set by setting the percentage of the time in each cycle that the LEDs are on, rather than by varying the magnitude of a constant current that is passed through the LED. The duty cycles are set to maintain the color of the light source at a target value and to set the overall intensity of light generated by the light source.

The color of light source 40 is maintained by a servo loop that compares the output of color sensor 46 to target values provided by light source controller 48. The difference between the observed signals and the target signals is generated by a difference circuit 47 whose output is provided to pulse width modulation generator 49. Pulse width modulation generator 49 adjusts the duty factor for each set of LEDs to minimize the error signals. A set of current drivers 51-53 provides the current to each set of LEDs.

The LEDs and control circuitry require DC power. Hence, light source 40 must include some form of DC power supply 56 that transforms the normal AC power line power to DC. To simplify the drawing, the various power connections between power supply 56 and the components powered thereby have been omitted.

Since light source 40 already includes a considerable amount of computation and control circuitry, it has been suggested that the control circuitry could benefit from a communication interface 55 that allows the light source to receive commands directly from a user or over the AC power lines from some master control device. The commands could set the color of the light provided by the light source, and provide the dimming of the light source, or the turning on and off of the light source.

The present invention is based on the observation that providing all of the functionality described above in a single “light bulb” package is economically inefficient. First, it should be noted that the control circuitry and power supply components have lifetimes that are significantly longer than the LED components. This is particularly relevant to the case of high power LEDs. Hence, disposing of the entire light bulb results in the loss of the longer-lived components. These longer-lived components represent a significant fraction of the cost of the light bulb, and hence, disposing of them prior to the end of their useful lifetime increases the cost of the lighting system.

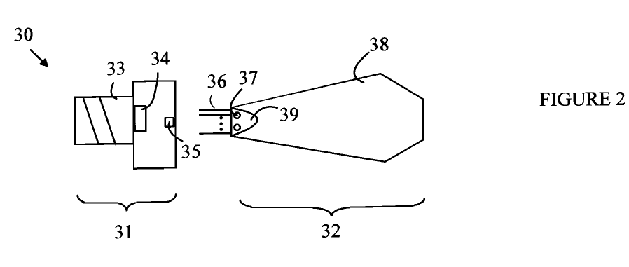

Refer now to FIG. 2, which is a cross-sectional view of one embodiment of a light source according to the present invention. Light source 30 includes two separate components, a base unit 31 and a light generation unit 32. Base unit 31 includes an adapter 33 that mates with a conventional light bulb socket. Base unit 31 also includes a power converter 34 and a controller 35 that provides the drivers, servo loop, photodetectors, and communication interface if one is present. Controller 35 is positioned such that the photodetectors receive light from light generation section 32 when the light source is powered.

Light generation section 32 includes the LEDs 37 and a light mixing structure 39. Light generation section 32 could also include a housing 38 that provides the appearance of a conventional light bulb. Housing 38 can also be used to assure that light source 30 has the same outside dimensions as a conventional light bulb so that lamp shades or other devices that are designed to clamp onto a conventional light bulb can be utilized with light source 30.

Finally, light generation section 32 includes a number of pins that mate with a corresponding socket in base section 31. If light source 30 is designed to provide a variable color source, there will, in general, be one pin 36 for each color of light plus one pin that provides a common ground. However, other numbers of pins could be utilized.

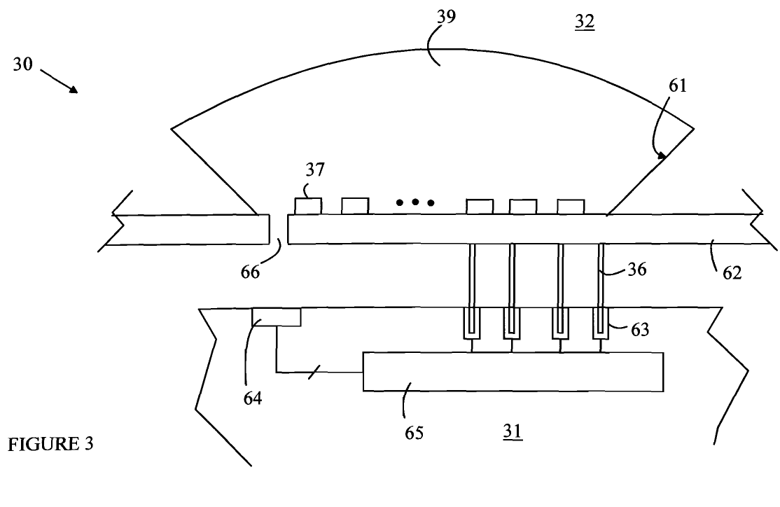

Refer now to FIG. 3, which is a magnified cross-sectional view of a portion of light source 30. Light generation section 32 includes a plurality of LEDs 37 that are mounted on, and connected to, a substrate 62 that includes electrical traces for powering each LED. To simplify the drawing, the electrical connections of the LEDs to substrate 62 have been omitted. Typically, mixing structure 39 is implemented by encapsulating the LEDs in a clear material such as epoxy or silicone that includes scattering centers that scatter the light generated by the LEDs. Hence, the light source appears to be an extended source having the dimensions of the mixing structure rather than individual LEDs. A reflector 61 redirects light scattered in the sideways directions to the forward direction.

Substrate 62 includes a transparent window 66 that allows a small portion of the light in the mixing structure to reach photodetector 64. The LEDs are grouped by the color of light generated by the LEDs. All of the LEDs of a particular color are connected in one or more chains of LEDs. Within each chain, the LEDs are connected in series so that each LED receives the same current. There are a plurality of colors of LEDs in the light source. Photodetector 64 provides a plurality of intensity signals in which each signal measures the light in a particular band of wavelengths. A servo controller 65 maintains the current through each string such that the light leaving light source 30 is perceived to be a predetermined color independent of the aging of the LEDs. Servo controller 65 includes the drivers for the various strings and couples the power to light generating section 32 through receptacles 63 that mate with the pins 36.

To simplify FIG. 3, the power supply and optional communications interface have been omitted from the drawing. The communication interface could be incorporated in servo controller 65. It should also be noted that photodetector 64 could be part of the same chip as servo controller 65 since both components can be constructed in CMOS.

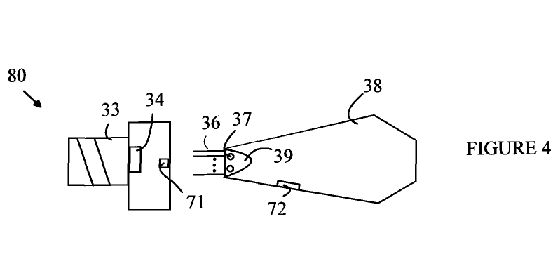

In the above described embodiments, the photodetector is included in the base section rather than in the light generation section. However, embodiments in which the photodetector is included in the light generation section can also be constructed. Refer now to FIG. 4, which is a cross-sectional view of another embodiment of a light source according to the present invention. Light source 80 is similar to light source 30 described above. However, controller 35 shown in FIG. 2 has been split into a controller 71 that lacks the photodetector functionality and a photodetector 72 that is now part of the light generation section. Photodetector 72 is connected to two or more of the pins shown at 36.

Photodetector 72 is preferably mounted at a location at which it samples the light generated by all of the LEDs with equal efficiency. In light source 80, photodetector 72 is mounted on the inside of housing 38. However, embodiments in which the photodetector is mounted within mixing structure 39 could also be constructed.

In the above-described embodiments of the present invention, mixing structure 39 is separate from housing 38. However, embodiments in which housing 38 also provides the mixing function could also be constructed. For example, the surface of housing 38 could include scattering centers that perform the mixing function in a manner analogous to a frosted glass light bulb. Alternatively, mixing structure 39 could be constructed from a solid material such as epoxy and provide a shape that emulates the shape of a conventional light bulb.

It should be noted that a base section according to the present invention could be used with a plurality of different light generation sections. Hence, the number of separate parts that must be inventoried is reduced. In addition, since the components in the base section have longer lifetimes than the LEDs in the light generation section, the base sections can be recycled when the light generation section is replaced.

As noted above, in one embodiment of the present invention, the base section includes a communication interface that sends and receives information over the power line connection. Such power line data communications are known to the art, and hence, will not be discussed in detail here. In the present invention, the communication interface could be used to set the color of light generated by the light source. One method for specifying the color to be maintained is to store target values for the photodetector signals. In this case, the controller servos the LED currents such that the photodetector signals match the stored target values.

If the base section is intended to function with only one type of light generation section, then the controller can be pre-programmed with the target values to be maintained. If, however, the base unit is to be used with a variety of light generation sections, or the color is to be under the user's control during the operation of the light source, then some means for inputting the target values that are to be utilized is required. The communication interface can be utilized for this programming function using a suitable console or computer interface. In addition, the communication interface could be utilized to control the light from a household controller in a manner analogous to that used in household automation systems that utilize power line communication interfaces. In such schemes, the user could alter both the color and intensity of the light source while the light source is operating.

The above-described embodiments of the present invention utilize a color sensor to correct for color shifts resulting from aging. However, there are also color shifts that arise from thermal effects. As the LEDs heat up, the efficiency of conversion of electricity to light decreases. The decrease in efficiency is different for different color LEDs. Hence, even without aging, some form of color correction is required to maintain the color of the light from the source at the desired color point.

Color shifts due to thermal effects can, in principle, be corrected by using a temperature sensor as opposed to a color sensor. Color shifts resulting from thermal effects take place over a time period that is short compared to the time over which the output of an LED decreases due to aging. Hence, changes due to heating can be calibrated to determine a light output versus temperature curve for each LED. This curve will be valid for some predetermined length of time after the light source is turned on. In addition, the rate of aging for a particular type of LED can also be calibrated as a function of the amount of time the LED is turned on at a particular current. Hence, if the temperature and total operating time are known for each LED, the controller can correct the currents sent to each LED to take into account the age of the LED and the current temperature of the light source. It should be noted that the controller can track the operating time for each LED, since the controller already includes some form of clock that is used to time the waveform that is sent to the LEDs.

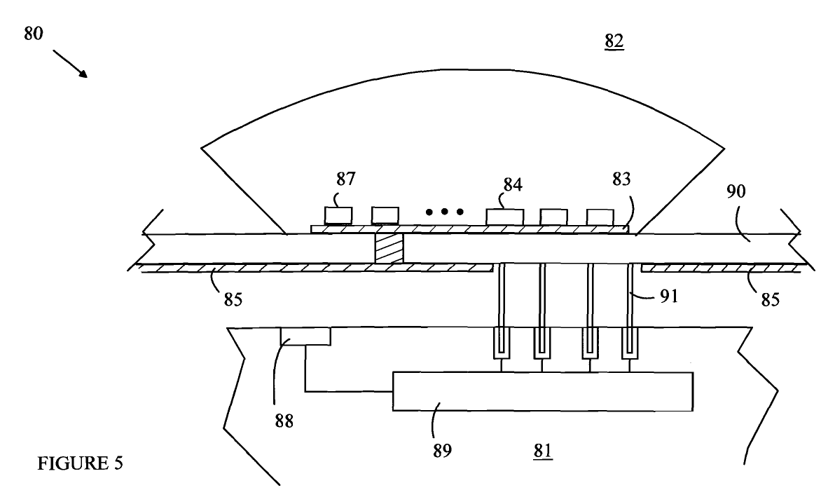

Refer now to FIG. 5, which is a magnified cross-sectional view of a portion of light source 80 according to another embodiment of the present invention. Light generation section 82 includes a plurality of LEDs 87 that are mounted on, and connected to, a substrate 90 that includes electrical traces for powering each LED. The LEDs are also in thermal contact with a heat conducting layer 83 that transfers heat from the LEDs to a heat radiating surface such as surface 85. The temperature of the LEDs can be measured by measuring the temperature of layer 83 or surface 85. For example, a heat sensor 84 could be provided on layer 83 and connected to controller 89 by two of the pins shown at 91. Alternatively, an infra-red sensor 88 could be included in base section 81. Sensor 88 views surface 85 and generates a signal related to the temperature of surface 85. Sensor 88 could also be replaced by a thermistor that measures the temperature of surface 85.

In practice, a control strategy based on measuring the temperature of the light source and using a calibration curve to alter the average current to each LED requires less computational resources than using a servo based on a photodetector. In the servo-based systems, the photodetector must measure the light output of each string of LEDs in the light source. Typically, the photodetector includes three photodiodes with bandpass filters over each photodiode. In practice, each photodiode receives light from more than one color of LED even with the bandpass filters. Hence, the controller must correct the photodiode output signals mathematically to provide signals that are related to the light output of each string of LEDs. This requires significant computational resources.

A temperature sensor on the other hand can be implemented with a thermistor connected to the substrate on which the LEDs are mounted or by viewing that substrate with an infrared photodiode. The infrared photodiode can be used in place of photodetector 64 shown in FIG. 3. In this case, window 66 is not needed, since the infrared detector needs only to view the bottom surface of substrate 62. Hence, the sensors are simpler and less expensive in a system controlled by measuring temperature. Second, the computational resources needed to implement a look-up table that holds the temperature versus efficiency data for each type of LED are also significantly less than those needed to correct the photodiode signals.

Hence, the cost factors can be traded against the accuracy with which the color shifts due to aging and temperature are corrected. For lighting purposes, the improvement in color control is not always worth the additional cost.

Various modifications to the present invention will become apparent to those skilled in the art from the foregoing description and accompanying drawings. Accordingly, the present invention is to be limited solely by the scope of the following claims.

What is claimed is:

1. A lighting unit comprising:
a light generating section comprising:
one or more groups of LEDs, each group emitting light of a different spectrum than said other groups; and
a plurality of light generating section connectors that provide power to said LEDs, each group of LEDs generating light at an intensity determined by a corresponding control signal received on said light generating section connectors; and
a base section comprising:
a controller that generates and couples said control signals to said light generating section connectors; and
a plurality of base section connectors that are connected to said controller, each base section connector reversibly mating with a corresponding one of said light generating section connectors.

2. The lighting unit of claim 1 further comprising an adapter that connects said lighting unit to an AC power receptacle configured to receive an incandescent lamp or a fluorescent lamp; and
a power converter that converts AC power from said adapter to DC power that powers said controller.

3. The lighting unit of claim 1 further comprising a light mixing structure that generates a light output that is more uniform in color and intensity than that generated by said groups of LEDs.

4. The lighting unit of claim 1 further comprising a sensor that periodically measures a parameter related to said intensity of light generated by each group of LEDs during the normal operation of said lighting unit, said parameter being utilized by said controller in generating said control signals.

5. The lighting unit of claim 4 wherein said sensor comprises a photodetector that measures said intensity of light generated by each of said groups of LEDs.

6. The lighting unit of claim 5 wherein said sensor is located in said light generating section.

7. The lighting unit of claim 5 wherein said sensor is located in said base section.

8. The lighting unit of claim 4 wherein said sensor comprises a device for measuring a temperature related to said LEDs.

9. The lighting unit of claim 8 wherein said LEDs are in thermal contact with a heat spreading layer that has a temperature related to a temperature of one of said LEDs and wherein said sensor measures said temperature of said heat spreading layer.

10. The lighting unit of claim 9 wherein said sensor comprises a temperature sensor attached to said heat spreading layer and connected to said controller by said light generating section connectors.

11. The lighting unit of claim 9 wherein said sensor comprises an infrared detector in said base section.

12. The lighting unit of claim 2 wherein said base section further comprises a communication interface for sending and receiving information between said controller and a device connected to said AC power receptacle.

13. The lighting unit of claim 3 wherein said light generating section further comprises a housing that contains said LEDs and said mixing structure, said housing having a shape and dimensions that match a corresponding commercially available incandescent or fluorescent lamp.
